(19) United States
(12) Patent Application Publication
(10) Pub. No.: US 2026/0358029 A1
(43) Pub. Date: Nov. 12, 2026

(54) AIR-CONDITIONER AND AIR-CONDITIONING SYSTEM

(71) Applicant: Mitsubishi Electric Corporation, Tokyo (JP)

(72) Inventors: Masahiro ITO, Tokyo (JP); Mitsuhiro ISHIGAKI, Tokyo (JP)

(21) Appl. No.: 19/125,598

(22) PCT Filed: Dec. 5, 2022
(86) PCT No.: PCT/JP2022/044759

§ 371 Date: Apr. 29, 2025

(51) Int. Cl. F25B 43/00; F25B 39/00; F25B 39/02; F25B 41/30; F25B 49/02; G01K 1/02

(52) U.S. Cl. CPC F25B 43/006; F25B 39/00; F25B 41/30; F25B 49/022; G01K 1/026; F25B 39/02; F25B 2600/05; F25B 2700/19; F25B 2700/21

(57) ABSTRACT

An air-conditioner includes a refrigerant circuit including a compressor, a condenser, at least one expansion valve, and an evaporator and configured to circulate refrigerant, a control device to control the refrigerant circuit, an accumulator where liquid refrigerant is stored, the accumulator being configured to separate refrigerant that flows through the refrigerant circuit into liquid refrigerant and gas refrigerant, a first temperature sensor to measure a temperature of refrigerant that flows into the accumulator, and a second temperature sensor to measure a temperature of refrigerant that flows out of the accumulator. The accumulator is arranged between the compressor and the evaporator. The control device calculates an amount of liquid refrigerant stored in the accumulator based on a first measurement result from the first temperature sensor and a second measurement result from the second temperature sensor.

### TECHNICAL FIELD

The present disclosure relates to an air-conditioner and an air-conditioning system.

### BACKGROUND ART

An air-conditioner is configured to cool or heat the inside of a room which is to be air-conditioned by circulation of refrigerant through a refrigerant circuit. In general, an amount of refrigerant necessary during a heating operation is smaller than an amount of refrigerant necessary during a cooling operation. Therefore, the amount of refrigerant to be filled in the refrigerant circuit of the air-conditioner is determined based on the amount of refrigerant necessary during the cooling operation. Excess refrigerant not used during the heating operation is stored in an accumulator provided between a compressor and an evaporator included in the refrigerant circuit. An operator who sets or inspects the air-conditioner can determine whether or not the amount of refrigerant that circulates through the refrigerant circuit is appropriate by checking the amount of refrigerant stored in the accumulator.

WO2019/065242 (PTL 1) discloses a liquid level sensor to sense a liquid level height of refrigerant stored in an accumulator. This liquid level sensor is configured to measure a surface temperature of the accumulator with a plurality of temperature sensors provided in a height direction of the accumulator, with the accumulator being heated by a heater, and it senses the liquid level height of refrigerant stored in the accumulator based on a difference in temperature change in accordance with a state of refrigerant in the accumulator.

### CITATION LIST

### Patent Literature

PTL 1: WO2019/065242

### SUMMARY OF INVENTION

### Technical Problem

The liquid level sensor disclosed in WO2019/065242 can sense the amount of refrigerant stored in the accumulator. The heater and the plurality of temperature sensors, however, should specially be provided in the accumulator, and hence cost increases. Therefore, a technique to allow an operator who sets or inspects an air-conditioner to more inexpensively check the amount of refrigerant stored in the accumulator has been demanded.

The present disclosure was made to solve the problem above, and an object thereof is to provide a technique to allow an operator to more inexpensively check an amount of refrigerant stored in an accumulator.

### Solution to Problem

An air-conditioner according to the present disclosure includes a refrigerant circuit including a compressor, a condenser, at least one expansion valve, and an evaporator, the refrigerant circuit being configured to circulate refrigerant, a control device configured to control the refrigerant circuit, an accumulator where liquid refrigerant is stored, the accumulator being configured to separate refrigerant that flows through the refrigerant circuit into liquid refrigerant and gas refrigerant, a first temperature sensor configured to measure a temperature of the refrigerant that flows into the accumulator, and a second temperature sensor configured to measure a temperature of the refrigerant that flows out of the accumulator. The accumulator is arranged between the compressor and the evaporator. The control device calculates an amount of the liquid refrigerant stored in the accumulator, based on a first measurement result from the first temperature sensor and a second measurement result from the second temperature sensor.

An air-conditioning system according to the present disclosure includes the air-conditioner described above and a user device to give a notification of the amount of the liquid refrigerant stored in the accumulator, the amount being calculated by the air-conditioner.

### Advantageous Effects of Invention

According to the present disclosure, since the air-conditioner can calculate the amount of liquid refrigerant stored in the accumulator based on the temperature of refrigerant that flows into the accumulator and the temperature of refrigerant that flows out of the accumulator, an operator can more inexpensively check the amount of liquid refrigerant stored in the accumulator.

### BRIEF DESCRIPTION OF DRAWINGS

FIG. 1 is a diagram showing a configuration of an air-conditioner and an air-conditioning system according to a first embodiment.

FIG. 2 is a pressure-enthalpy chart of a refrigeration cycle in the air-conditioner according to the first embodiment.

FIG. 3 is a diagram for illustrating an internal configuration of an accumulator according to the first embodiment.

FIG. 4 is a timing chart for illustrating state change in the refrigerant cycle when the air-conditioner according to the first embodiment performs a refrigerant amount detection process.

FIG. 5 shows a graph of change in liquid level height of liquid refrigerant in the accumulator with respect to a difference between a degree of superheat of refrigerant that flows into the accumulator and a degree of superheat of refrigerant that flows out of the accumulator.

FIG. 6 is a flowchart for illustrating the refrigerant amount detection process performed by the air-conditioner according to the first embodiment.

FIG. 7 is a diagram showing a configuration of the air-conditioner and the air-conditioning system according to a second embodiment.

### DESCRIPTION OF EMBODIMENTS

An embodiment of the present disclosure will be described in detail below with reference to the drawings. Though a plurality of embodiments will be described below, combination of features described in the embodiments as appropriate is originally intended. The same or corresponding elements in the drawings have the same reference characters allotted and description thereof will not be repeated.

### First Embodiment

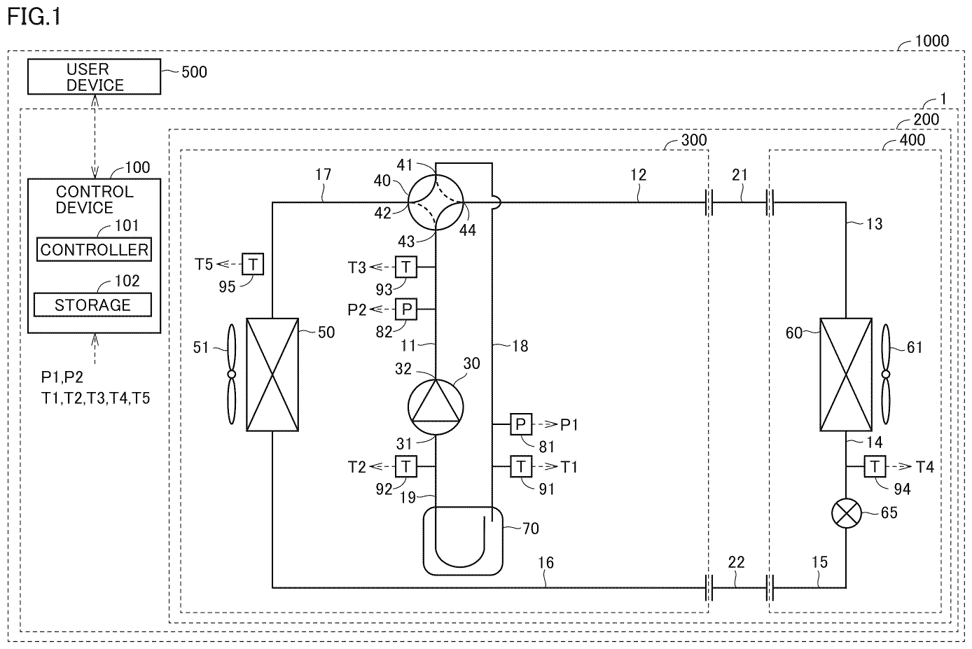

An air-conditioner 1 and an air-conditioning system 1000 according to a first embodiment will be described with reference to FIG. 1. FIG. 1 is a diagram showing a configuration of air-conditioner 1 and air-conditioning system 1000 according to the first embodiment. FIG. 1 functionally shows connection relation and an arrangement configuration of elements in air-conditioner 1, and does not necessarily show arrangement in a physical space.

As shown in FIG. 1, air-conditioning system 1000 includes air-conditioner 1 and a user device 500.

Air-conditioner 1 includes a refrigerant circuit 200 and a control device 100. Refrigerant circuit 200 includes an outdoor unit 300 and an indoor unit 400. Outdoor unit 300 and indoor unit 400 are connected to each other through an extension pipe 21 and an extension pipe 22 and refrigerant circulates between outdoor unit 300 and indoor unit 400.

Outdoor unit 300 is generally set in the outdoors which is not to be air-conditioned, and includes a four-way valve 40, a compressor 30, an outdoor heat exchanger 50, and an outdoor fan 51.

Four-way valve 40 includes a connection port 41, a connection port 42, a connection port 43, and a connection port 44. Connection port 41 of four-way valve 40 is connected to an inlet 31 of compressor 30 through a pipe 18 and a pipe 19. Connection port 42 of four-way valve 40 is connected to outdoor heat exchanger 50 through a pipe 17. Connection port 43 of four-way valve 40 is connected to an outlet 32 of compressor 30 through a pipe 11. Connection port 44 of four-way valve 40 is connected to indoor unit 400 through a pipe 12 and extension pipe 21. Four-way valve 40 is configured to switch an internal communication state under the control by control device 100.

Compressor 30 is configured to be activated and deactivated and further to change in rotation speed during operations under the control by control device 100. Control device 100 changes a drive frequency of compressor 30 to any drive frequency by controlling compressor 30. The number of rotations, that is, a rotation speed per unit time, of compressor 30 is changed with change in drive frequency, and hence an amount of discharge of refrigerant changes. Various types of compressors can be adopted as compressor 30, and for example, a compressor of a scroll type, a rotary type, or a screw type can be adopted as compressor 30.

Outdoor heat exchanger 50 performs heat exchange between air suctioned from the outdoors by outdoor fan 51, that is, outside air, and refrigerant. One end side of outdoor heat exchanger 50 is connected to connection port 42 of four-way valve 40 through pipe 17. The other end side of outdoor heat exchanger 50 is connected to indoor unit 400 through a pipe 16 and extension pipe 22.

Outdoor fan 51 is configured to be activated and deactivated and further to change in rotation speed during operations under the control by control device 100. Control device 100 changes a drive frequency of outdoor fan 51 to any drive frequency by controlling outdoor fan 51. The number of rotations, that is, a rotation speed per unit time, of outdoor fan 51 is changed with change in drive frequency, and hence an amount of air sent to outdoor heat exchanger 50 changes.

Indoor unit 400 is generally set in an indoor space which is to be air-conditioned, and includes an indoor heat exchanger 60, an indoor fan 61, and an indoor expansion valve 65.

Indoor heat exchanger 60 performs heat exchange between air suctioned from the indoors by indoor fan 61 and refrigerant. One end side of indoor heat exchanger 60 is connected to outdoor unit 300 through a pipe 13 and extension pipe 21. The other end side of indoor heat exchanger 60 is connected to indoor expansion valve 65 through a pipe 14.

Indoor fan 61 is configured to be activated and deactivated and further to change in rotation speed during operations under the control by control device 100. Control device 100 changes a drive frequency of indoor fan 61 to any drive frequency by controlling indoor fan 61. The number of rotations, that is, a rotation speed per unit time, of indoor fan 61 is changed with change in drive frequency, and hence an amount of air sent to indoor heat exchanger 60 changes.

Indoor expansion valve 65 is, for example, an electronic expansion valve an opening of which is adjusted under the control by control device 100. Indoor expansion valve 65 lowers a pressure of refrigerant that flows in and allows outflow of refrigerant obtained by pressure reduction. Control device 100 can adjust an amount of pressure reduction of refrigerant by adjusting the opening of indoor expansion valve 65. One end side of indoor expansion valve 65 is connected to indoor heat exchanger 60 through pipe 14. The other end side of indoor expansion valve 65 is connected to outdoor unit 300 through a pipe 15 and extension pipe 22.

Control device 100 includes a controller 101 and a storage 102. Control device 100 can communicate with each actuator of refrigerant circuit 200, such as compressor 30, indoor expansion valve 65, four-way valve 40, outdoor fan 51, and indoor fan 61 so as to control each actuator of refrigerant circuit 200. Control device 100 may be mounted on one of outdoor unit 300 and indoor unit 400 or may be separate from outdoor unit 300 and indoor unit 400.

Controller 101 is a computing entity to control each actuator of refrigerant circuit 200 by executing various programs. Controller 101 is implemented by a computer such as a processor. The processor is implemented, for example, by a microcontroller, a central processing unit (CPU), a micro-processing unit (MPU), or the like. Though the processor performs functions to perform various types of processing by executing a program, some or all of these functions may be performed by dedicated hardware circuitry such as an application specific integrated circuit (ASIC) or a field-programmable gate array (FPGA). The “processor” is not limited to a processor in a narrow sense that performs processing in accordance with a stored program architecture like the CPU or the MPU, but may encompass hard-wired circuitry such as the ASIC or the FPGA. Therefore, the processor can also be read as processing circuitry, processing by which is defined in advance by a computer readable code and/or hard-wired circuitry. The processor may be implemented by a single chip or a plurality of chips. Furthermore, the processor and relating processing circuitry may be implemented by a plurality of computers connected to one another through wires or wirelessly over a local area network or a wireless network. The processor and the relating processing circuitry may be implemented by a cloud computer that performs remote computation based on input data and outputs a result of computation to another device located at a remote position.

Storage 102 provides a storage area where a program code, a work memory, or the like is stored in execution of various programs by the processor of controller 101. Storage 102 may be one or more non-transitory computer readable media. Examples of storage 102 include a volatile memory such as a dynamic random access memory (DRAM) and a static random access memory (SRAM), or a non-volatile memory such as a read only memory (ROM) and a flash memory. Storage 102 may be one or more one or more computer readable storage media. Examples of storage 102 include a storage device such as a hard disk drive (HDD) and a solid state drive (SSD). Controller 101 controls each actuator of refrigerant circuit 200 by executing a program stored in storage 102.

User device 500 is configured to communicate with control device 100 over a network. User device 500 is an information terminal used by a user such as an operator. User device 500 may be implemented by a general-purpose computer or a dedicated computer for controlling air-conditioner 1. For example, user device 500 may be an information terminal that performs prescribed information processing, such as a desktop personal computer (PC), a laptop PC, a smartphone, a smartwatch, a wearable device, a tablet PC, and a remote controller provided in a building. The user such as an operator can use user device 500 to control air-conditioner 1, or can view data obtained from air-conditioner 1 on a not-shown display included in user device 500.

Air-conditioner 1 further includes a pressure sensor 81, a pressure sensor 82, a temperature sensor 91, a temperature sensor 92, a temperature sensor 93, a temperature sensor 94, and a temperature sensor 95.

Pressure sensor 81 is provided between an inlet side of accumulator 70 and the evaporator, and measures a pressure of refrigerant that flows out of the evaporator and flows into accumulator 70. A refrigerant pressure P1 measured by pressure sensor 81 is transmitted to control device 100.

Pressure sensor 82 is provided between outlet 32 of compressor 30 and the condenser, and measures a pressure of refrigerant discharged from compressor 30. A refrigerant pressure P2 measured by pressure sensor 82 is transmitted to control device 100.

Temperature sensor 91 is provided between the inlet side of accumulator 70 and the evaporator, and measures a temperature of refrigerant that flows into accumulator 70. A refrigerant temperature T1 measured by temperature sensor 91 is transmitted to control device 100. Temperature sensor 91 is an exemplary “first temperature sensor.” Refrigerant temperature T1 measured by temperature sensor 91 is an exemplary “first measurement result.”

Temperature sensor 92 is provided between an outlet side of accumulator 70 and inlet 31 of compressor 30, and measures a temperature of refrigerant that flows out of accumulator 70. A refrigerant temperature T2 measured by temperature sensor 92 is transmitted to control device 100. Temperature sensor 92 is an exemplary “second temperature sensor.” Refrigerant temperature T2 measured by temperature sensor 92 is an exemplary “second measurement result.”

Temperature sensor 93 is provided between outlet 32 of compressor 30 and the condenser, and measures a temperature of refrigerant discharged from compressor 30. A refrigerant temperature T3 measured by temperature sensor 93 is transmitted to control device 100.

Temperature sensor 94 is provided between indoor heat exchanger 60 and indoor expansion valve 65, and measures a temperature of refrigerant that flows out of indoor heat exchanger 60. A refrigerant temperature T4 measured by temperature sensor 94 is transmitted to control device 100.

Temperature sensor 95 is provided in or around outdoor heat exchanger 50, and measures an outdoor temperature. An outside air temperature T5 measured by temperature sensor 95 is transmitted to control device 100.

Air-conditioner 1 configured as described above is controlled to be in one of a plurality of types of operation modes including a heating operation mode in which an indoor space is heated and a cooling operation mode in which the indoor space is cooled.

An operation of air-conditioner 1 in the heating operation mode will initially be described. As shown with a solid line in FIG. 1, in the heating operation mode, a state of communication inside four-way valve 40 is such that connection port 41 communicates with connection port 42 and connection port 43 communicates with connection port 44. In other words, in the heating operation mode, inlet 31 of compressor 30 is connected to a side of outdoor heat exchanger 50 and outlet 32 of compressor 30 is connected to a side of indoor heat exchanger 60.

Compressor 30 suctions low-temperature and low-pressure gas refrigerant that flows in from outdoor heat exchanger 50 and raises a pressure of gas refrigerant by compressing suctioned gas refrigerant. Compressor 30 discharges high-temperature and high-pressure gas refrigerant obtained by compression to indoor heat exchanger 60.

In the heating operation mode, indoor heat exchanger 60 functions as the condenser. Indoor heat exchanger 60 has high-temperature and high-pressure gas refrigerant from compressor 30 exchange heat with air suctioned from the indoor space by indoor fan 61. Gas refrigerant that has radiated heat to air as a result of this heat exchange is condensed inside indoor heat exchanger 60 to change to high-temperature and high-pressure liquid refrigerant. High-temperature and high-pressure liquid refrigerant obtained in indoor heat exchanger 60 flows out to indoor expansion valve 65. Air that has absorbed heat from gas refrigerant in indoor heat exchanger 60 is again sent into the indoor space. The indoor space is thus heated.

Indoor expansion valve 65 lowers the pressure of high-temperature and high-pressure liquid refrigerant from indoor heat exchanger 60. Low-temperature and low-pressure gas-liquid two-phase refrigerant obtained in indoor expansion valve 65 flows out to outdoor heat exchanger 50.

In the heating operation mode, outdoor heat exchanger 50 functions as the evaporator. Outdoor heat exchanger 50 has low-temperature and low-pressure gas-liquid two-phase refrigerant from indoor expansion valve 65 exchange heat with air suctioned from the outdoors by outdoor fan 51. Gas-liquid two-phase refrigerant that has absorbed heat from air as a result of this heat exchange evaporates inside outdoor heat exchanger 50 to change to low-temperature and low-pressure gas refrigerant. Low-temperature and low-pressure gas refrigerant obtained in outdoor heat exchanger 50 flows out to compressor 30.

Thus, in the heating operation mode, refrigerant flows sequentially through compressor 30, indoor heat exchanger 60 (condenser), indoor expansion valve 65, and outdoor heat exchanger 50 (evaporator).

An operation of air-conditioner 1 in the cooling operation mode will now be described. As shown with a dashed line in FIG. 1, in the cooling operation mode, the state of communication inside four-way valve 40 is such that connection port 41 communicates with connection port 44 and connection port 42 communicates with connection port 43. In other words, in the cooling operation mode, inlet 31 of compressor 30 is connected to the side of indoor heat exchanger 60 and outlet 32 of compressor 30 is connected to the side of outdoor heat exchanger 50.

Compressor 30 suctions low-temperature and low-pressure gas refrigerant from indoor heat exchanger 60 and raises the pressure of gas refrigerant by compressing suctioned gas refrigerant. Compressor 30 discharges high-temperature and high-pressure gas refrigerant obtained by compression to outdoor heat exchanger 50.

In the cooling operation mode, outdoor heat exchanger 50 functions as the condenser. Outdoor heat exchanger 50 has high-temperature and high-pressure gas refrigerant from compressor 30 exchange heat with air suctioned from the outdoors by outdoor fan 51. Gas refrigerant that has radiated heat to air as a result of this heat exchange is condensed inside outdoor heat exchanger 50 to change to high-temperature and high-pressure liquid refrigerant. High-temperature and high-pressure liquid refrigerant obtained in outdoor heat exchanger 50 flows out to indoor expansion valve 65.

Indoor expansion valve 65 lowers the pressure of high-temperature and high-pressure liquid refrigerant from outdoor heat exchanger 50. Low-temperature and low-pressure gas-liquid two-phase refrigerant obtained by pressure reduction in indoor expansion valve 65 flows out to indoor heat exchanger 60.

In the cooling operation mode, indoor heat exchanger 60 functions as the evaporator. Indoor heat exchanger 60 has low-temperature and low-pressure gas-liquid two-phase refrigerant from indoor expansion valve 65 exchange heat with air suctioned from the indoors by indoor fan 61. Gas-liquid two-phase refrigerant that has absorbed heat from air as a result of this heat exchange evaporates inside indoor heat exchanger 60 to change to low-temperature and low-pressure gas refrigerant. Low-temperature and low-pressure gas refrigerant obtained in indoor heat exchanger 60 flows out to compressor 30. Air from which heat has been absorbed by gas refrigerant in indoor heat exchanger 60 is again sent into the indoor space. The indoor space is thus cooled.

Thus, in the cooling operation mode, refrigerant flows sequentially through compressor 30, outdoor heat exchanger 50 (condenser), indoor expansion valve 65, and indoor heat exchanger 60 (evaporator).

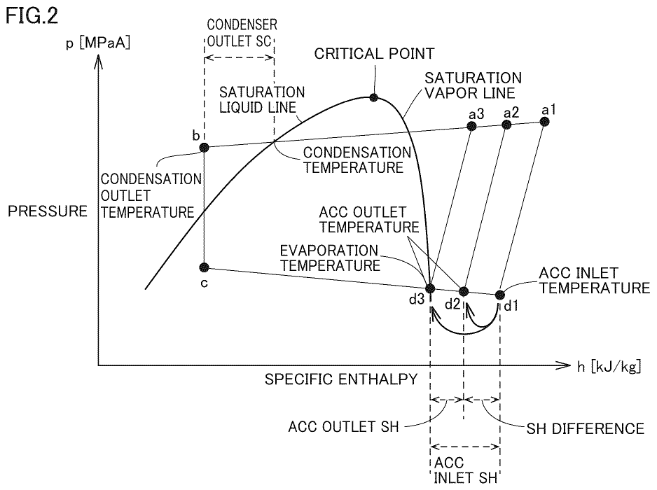

FIG. 2 is a pressure-enthalpy chart of a refrigeration cycle in air-conditioner 1 according to the first embodiment. In the pressure-enthalpy chart in FIG. 2, the ordinate represents an absolute pressure p and the abscissa represents specific enthalpy h. Points a1, a2, and a3 in FIG. 2 each indicate a state of refrigerant between outlet 32 of compressor 30 and the condenser. A point b indicates the state of refrigerant between the condenser and indoor expansion valve 65. A point c indicates the state of refrigerant between indoor expansion valve 65 and the evaporator. Points d1, d2, and d3 each indicate the state of refrigerant between the evaporator and inlet 31 of compressor 30.

In the refrigeration cycle, state change of refrigerant from points d1, d2, and d3 to respective points a1, a2, and a3 represents state change of refrigerant resulting from flow thereof through compressor 30. State change of refrigerant from points a1, a2, and a3 to point b represents state change of refrigerant resulting from flow of refrigerant through the condenser. State change of refrigerant from point b to point c represents state change of refrigerant resulting from flow of refrigerant through indoor expansion valve 65. State change of refrigerant from point c to points d1, d2, and d3 represents state change of refrigerant resulting from flow of refrigerant through the evaporator.

In general, in air-conditioner 1, an amount of refrigerant necessary during the heating operation is smaller than an amount of refrigerant necessary during the cooling operation. Therefore, the amount of refrigerant to be filled in refrigerant circuit 200 of air-conditioner 1 is determined based on the amount of refrigerant necessary during the cooling operation, and in the heating operation, there may be excess refrigerant not used in the heating operation. Air-conditioner 1 then further includes accumulator 70 between compressor 30 and the evaporator, and it is configured to store excess refrigerant in accumulator 70. As shown in FIG. 1, in the heating operation mode, accumulator 70 is arranged between compressor 30 and outdoor heat exchanger 50. In the cooling operation mode, accumulator 70 is arranged between compressor 30 and indoor heat exchanger 60.

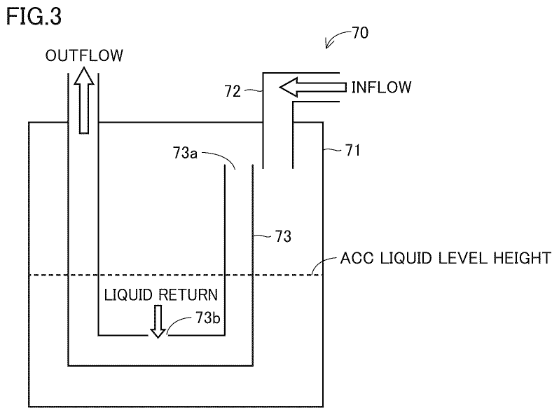

FIG. 3 is a diagram for illustrating an internal configuration of accumulator 70 according to the first embodiment. As shown in FIG. 3, accumulator 70 includes a container 71, an inflow pipe 72, and an outflow pipe 73.

Inflow pipe 72 is configured as being connectable to pipe 18 connected to an evaporator side and configured to introduce refrigerant that flows from the evaporator through pipe 18 into container 71. Of refrigerant introduced through inflow pipe 72, liquid refrigerant is stored in a lower portion of container 71 and gas refrigerant remains in an upper portion of container 71.

Outflow pipe 73 is configured as being connectable to pipe 19 connected to a side of compressor 30 and configured to introduce refrigerant stored in container 71 to inlet 31 of compressor 30 through pipe 19. Outflow pipe 73 is formed in a U shape, and includes a gas inlet 73a through which gas refrigerant remaining in the upper portion of container 71 is to be suctioned and a liquid inlet 73b through which liquid refrigerant stored in the lower portion of container 71 is to be suctioned. Gas refrigerant suctioned through gas inlet 73a passes through outflow pipe 73 and flows out to inlet 31 of compressor 30. Liquid refrigerant suctioned through liquid inlet 73b passes through outflow pipe 73 and flows out to inlet 31 of compressor 30. Since a diameter of liquid inlet 73b is smaller than a diameter of outflow pipe 73, only a small amount of liquid refrigerant is suctioned through liquid inlet 73b.

In accumulator 70 configured as described above, of refrigerant that has flowed from the evaporator through pipe 18, liquid refrigerant is stored in the lower portion of container 71 and gas refrigerant remains in the upper portion of container 71, so that refrigerant that flows through refrigerant circuit 200 can be separated into liquid refrigerant and gas refrigerant, and liquid refrigerant can be stored in container 71. Liquid refrigerant stored in container 71 flows into outflow pipe 73 by extremely small increments through liquid inlet 73b arranged therein and returns to inlet 31 of compressor 30 through outflow pipe 73.

Accumulator 70 will also be referred to as an “ACC” below as being abbreviated. A height of a liquid level of liquid refrigerant stored in container 71 of accumulator 70 will also be referred to as an “ACC liquid level height.” An amount of liquid refrigerant stored in container 71 of accumulator 70 will also be referred to as an “ACC liquid refrigerant amount.” Return of liquid refrigerant stored in container 71 to outflow pipe 73 through liquid inlet 73b will also be referred to as “liquid return.”

The operator may fill refrigerant circuit 200 with refrigerant in setting air-conditioner 1 or additionally fill refrigerant circuit 200 of already-set air-conditioner 1 with refrigerant. At this time, the operator can check the amount of liquid refrigerant stored in accumulator 70 to thereby determine whether or not refrigerant circuit 200 has been filled with an appropriate amount of refrigerant. In addition, the operator can check the amount of liquid refrigerant stored in accumulator 70 in already-set air-conditioner 1 to also determine whether or not refrigerant leakage has occurred in refrigerant circuit 200. Thus, in setting or inspection of air-conditioner 1, the operator has to check the amount of liquid refrigerant stored in accumulator 70.

A method of sensing the ACC liquid level height based on a difference in temperature change in accordance with a state of refrigerant in accumulator 70 by heating accumulator 70 with a not-shown heater and measuring a surface temperature of accumulator 70 with a plurality of not-shown temperature sensors provided in a height direction of accumulator 70 is available as a method of checking the amount of liquid refrigerant stored in accumulator 70. For such a method, however, the heater and the plurality of temperature sensors should specially be provided in accumulator 70 and cost increases.

Air-conditioner 1 according to the first embodiment is then configured to allow more inexpensive checking of the amount of liquid refrigerant stored in accumulator 70 by performing a refrigerant amount detection process.

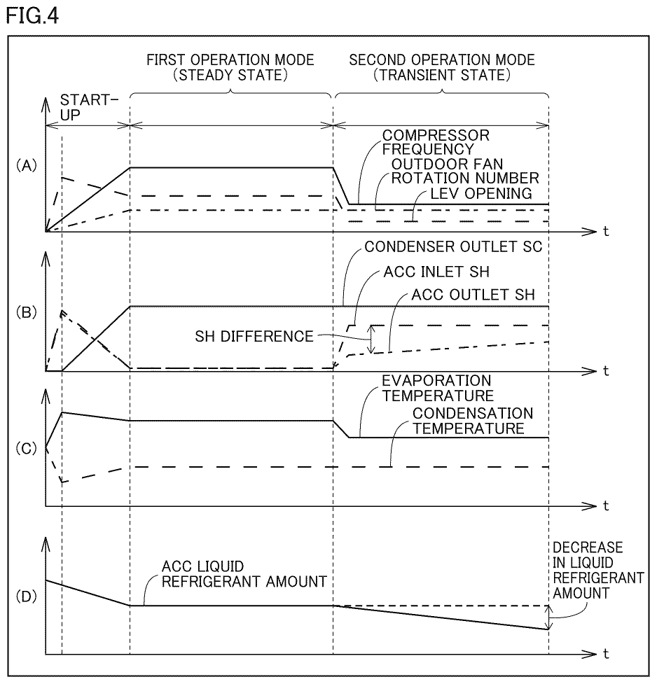

FIG. 4 is a timing chart for illustrating state change in the refrigeration cycle when air-conditioner 1 according to the first embodiment performs the refrigerant amount detection process. FIG. 4 shows state change in the refrigeration cycle when the refrigerant amount detection process is performed in the heating operation mode.

As shown in FIG. 4, in air-conditioner 1, control device 100 controls refrigerant circuit 200 in a first operation mode after start-up and thereafter controls refrigerant circuit 200 in a second operation mode.

FIG. 4(A) shows how a drive frequency of compressor 30 (which will also be referred to as a “compressor frequency” below), the number of rotations per unit time of outdoor fan 51 (which will also be referred to as an “outdoor fan rotation number” below), and an opening of indoor expansion valve 65 (which will also be referred to as an “LEV opening” below) change during start-up, during the first operation mode, and during the second operation mode. The compressor frequency, the outdoor fan rotation number, and the LEV opening are controlled by control device 100.

FIG. 4(B) shows how a degree of supercool at a condenser outlet (which will also be referred to as a “condenser outlet SC” below), a degree of superheat at an ACC inlet (which will also be referred to as an “ACC inlet SH” below), and a degree of superheat at an ACC outlet (which will also be referred to as an “ACC outlet SH” below) change during start-up, during the first operation mode, and during the second operation mode.

As shown in FIG. 2, the condenser outlet SC can be calculated by subtracting a refrigerant temperature at the condenser outlet from a condensation temperature. For example, control device 100 obtains from pressure sensor 82, pressure P2 of refrigerant discharged from compressor 30 and calculates a saturation temperature of refrigerant as the condensation temperature based on obtained refrigerant pressure P2. Furthermore, control device 100 obtains from temperature sensor 94, temperature T4 of refrigerant that flows out of indoor heat exchanger 60 which is the condenser. Control device 100 can calculate the condenser outlet SC by subtracting refrigerant temperature T4 from the saturation temperature calculated as the condensation temperature.

As shown in FIG. 2, the ACC inlet SH can be calculated by subtracting an evaporation temperature from the refrigerant temperature at the ACC inlet. For example, control device 100 obtains from temperature sensor 91, temperature T1 of refrigerant that flows into accumulator 70. Furthermore, control device 100 obtains from pressure sensor 81, pressure P1 of refrigerant that flows out of outdoor heat exchanger 50 which is the evaporator and calculates the saturation temperature of refrigerant as the evaporation temperature based on obtained refrigerant pressure P1. Control device 100 can calculate the ACC inlet SH by subtracting the evaporation temperature calculated based on refrigerant pressure P1 from refrigerant temperature T1. The ACC inlet SH is an exemplary “first degree of superheat.”

As shown in FIG. 2, the ACC outlet SH can be calculated by subtracting the evaporation temperature from the refrigerant temperature at the ACC outlet. For example, control device 100 obtains from temperature sensor 92, temperature T2 of refrigerant that flows out of accumulator 70. Furthermore, control device 100 obtains from pressure sensor 81, pressure P1 of refrigerant that flows out from outdoor heat exchanger 50 which is the evaporator and calculates the saturation temperature of refrigerant as the evaporation temperature based on obtained refrigerant pressure P1. Control device 100 can calculate the ACC outlet SH by subtracting the evaporation temperature calculated based on refrigerant pressure P1 from refrigerant temperature T2. The ACC outlet SH is an exemplary “second degree of superheat.”

FIG. 4(C) shows how the evaporation temperature and the condensation temperature change during start-up, during the first operation mode, and during the second operation mode.

FIG. 4(D) shows how the ACC liquid refrigerant amount changes during start-up, during the first operation mode, and during the second operation mode.

In air-conditioner 1, as control device 100 controls refrigerant circuit 200 in the first operation mode, the refrigeration cycle enters a steady state. Specifically, as shown in FIG. 4(A), in the first operation mode, air-conditioner 1 fixes the compressor frequency to a prescribed value such that the condensation temperature is constant, fixes the outdoor fan rotation number to a prescribed value such that the evaporation temperature is constant, and further fixes the LEV opening to a prescribed value such that the condenser outlet SC is constant. As shown in FIG. 4(B), in such a first operation mode, a difference (which will also be referred to as an “SH difference” below) between the ACC inlet SH and the ACC outlet SH becomes smaller than a prescribed value (for example, a value larger than 0). More specifically, in the first operation mode, the SH difference becomes 0 or substantially 0. In other words, in the first operation mode, the ACC inlet SH and the ACC outlet SH become equal or substantially equal to each other. As shown in FIG. 4(D), in the first operation mode, the ACC liquid refrigerant amount does not substantially change either.

Thus, while the refrigeration cycle is in the steady state in the first operation mode, the SH difference and the ACC liquid refrigerant amount are less likely to change, and hence air-conditioner 1 is unable to detect the ACC liquid refrigerant amount even based on the pressure and the temperature of refrigerant that flows into or out of accumulator 70, that is, refrigerant pressure P1 and refrigerant temperatures T1 and T2.

Then, in air-conditioner 1, control device 100 controls refrigerant circuit 200 in the first operation mode to set the refrigeration cycle to the steady state, and thereafter controls refrigerant circuit 200 in the second operation mode to change the state of the refrigeration cycle on purpose to set the refrigeration cycle to a transient state.

Specifically, as shown in FIG. 4(A), in the second operation mode, air-conditioner 1 changes the compressor frequency to set the compressor frequency in the second operation mode to be lower than the compressor frequency in the first operation mode. For example, air-conditioner 1 minimizes the compressor frequency in the second operation mode. In the second operation mode, air-conditioner 1 changes the LEV opening to set the LEV opening in the second operation mode to be smaller than the LEV opening in the first operation mode. In the second operation mode, on the other hand, air-conditioner 1 does not change the outdoor fan rotation number to set a volume of air flow by outdoor fan 51 in the second operation mode to be equal to the volume of air flow by outdoor fan 51 in the first operation mode. The outdoor fan rotation number in this case may be a maximum number of rotations.

As shown in FIG. 4(B), when air-conditioner 1 is controlled to the second operation mode, the ACC inlet SH becomes higher than the ACC outlet SH and the SH difference is produced. In other words, when air-conditioner 1 is controlled to the second operation mode, the SH difference becomes equal to or larger than a prescribed value (for example, a value larger than 0). In addition, as shown in FIG. 4(D), the ACC liquid refrigerant amount decreases.

The reason why the SH difference as described above is produced in the second operation mode will be explained. When the compressor frequency is lowered and the LEV opening is made smaller in the second operation mode from the steady state in the first operation mode, the amount of refrigerant that flows to the evaporator decreases. Since the outdoor fan rotation number is maintained without being changed in the evaporator, gasification of refrigerant is accelerated in the evaporator as compared with that in the first operation mode. Superheat gas produced by gasification in the evaporator flows into accumulator 70. Consequently, the refrigerant temperature at the ACC inlet temporarily increases. For example, as shown in FIG. 2, when the refrigerant temperature at the ACC inlet in the first operation mode is around the evaporation temperature, in the second operation mode, the refrigerant temperature at the ACC inlet increases to a value corresponding to point d1.

In accumulator 70, on the other hand, mixed refrigerant which is a mixture of gas refrigerant suctioned through gas inlet 73a and liquid refrigerant suctioned through liquid inlet 73b as a result of liquid return flows through outflow pipe 73 out to compressor 30. A temperature of mixed refrigerant is lowered by mixing into gas refrigerant, of liquid refrigerant lower in temperature than gas refrigerant. In other words, as an amount of liquid refrigerant [kg/h] that returns is larger, the refrigerant temperature at the ACC outlet becomes lower, and as the amount of liquid refrigerant that returns is smaller, the refrigerant temperature at the ACC outlet becomes higher. In addition, as the ACC liquid level height is higher or a flow velocity of refrigerant in outflow pipe 73 is higher, the amount of liquid refrigerant that returns becomes larger, and as the ACC liquid level height is lower or the flow velocity of refrigerant in outflow pipe 73 is lower, the amount of liquid refrigerant that returns becomes smaller. In other words, as the ACC liquid level height is higher or the flow velocity of refrigerant in outflow pipe 73 is higher, the refrigerant temperature at the ACC outlet becomes lower, and as the ACC liquid level height is lower or the flow velocity of refrigerant in outflow pipe 73 is lower, the refrigerant temperature at the ACC outlet becomes higher. For example, as shown in FIG. 2, in the second operation mode, in accordance with the amount of liquid refrigerant that returns, the refrigerant temperature at the ACC outlet lowers from a value corresponding to point d1 to a value corresponding to point d2 or point d3.

As air-conditioner 1 is thus controlled in the second operation mode, a difference can be produced between the refrigerant temperature at the ACC inlet and the refrigerant temperature at the ACC outlet in accordance with the amount of liquid refrigerant that returns, that is, the ACC liquid level height. In addition, as described above, the ACC inlet SH can be calculated by subtracting the evaporation temperature from the refrigerant temperature at the ACC inlet, and the ACC outlet SH can be calculated by subtracting the evaporation temperature from the refrigerant temperature at the ACC outlet. In view of the fact that the same evaporation temperature is used for calculation of the ACC inlet SH and the ACC outlet SH, the SH difference between the ACC inlet SH and the ACC outlet SH is in proportion to a difference between refrigerant temperature T1 at the ACC inlet and refrigerant temperature T2 at the ACC outlet. Therefore, when air-conditioner 1 is controlled to the second operation mode as shown in FIG. 4(B), the SH difference is produced by the difference between refrigerant temperature T1 at the ACC inlet and refrigerant temperature T2 at the ACC outlet.

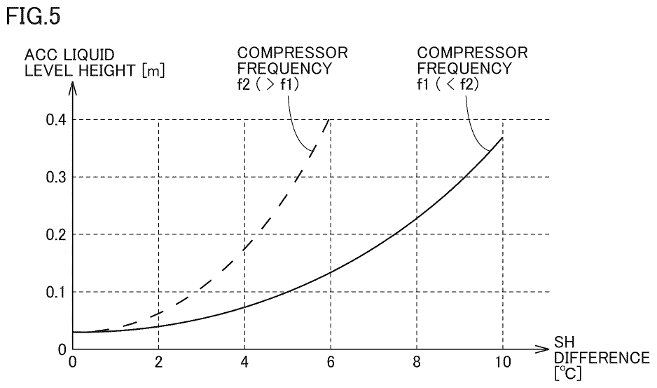

Relation between the SH difference and the ACC liquid level height will be described with reference to FIG. 5. FIG. 5 shows a graph of change in liquid level height (ACC liquid level height) of liquid refrigerant in accumulator 70 with respect to a difference (SH difference) between a degree of superheat (ACC inlet SH) of refrigerant that flows into accumulator 70 and a degree of superheat (ACC outlet SH) of refrigerant that flows out of accumulator 70.

As shown in FIG. 5, as the ACC liquid level height is lower, the refrigerant temperature at the ACC outlet becomes higher and hence the SH difference becomes smaller. As the ACC liquid level height is higher, on the other hand, the refrigerant temperature at the ACC outlet becomes lower and hence the SH difference becomes larger.

Furthermore, change in ACC liquid level height with respect to such an SH difference is different depending on the compressor frequency. Specifically, as the compressor frequency is lower, change in ACC liquid level height with respect to the SH difference becomes less. There is an upper limit of the ACC liquid level height depending on a volume of container 71. Therefore, as the compressor frequency is lower, a range within which change in ACC liquid level height with respect to the SH difference is detected can be secured.

For example, as shown in FIG. 5, in an example where the compressor frequency is set to f1, change in ACC liquid level height with respect to the SH difference is less than in an example where the compressor frequency is set to f2 which is higher than f1. In the example where the compressor frequency is set to f2, the ACC liquid level height can be detected only within a range where the SH difference is from 0 to 6 °C, whereas in the example where the compressor frequency is set to f1, the ACC liquid level height can be detected within a range where the SH difference is from 0 to 10 °C.

Therefore, when air-conditioner 1 lowers the compressor frequency in the second operation mode, it can minimize the compressor frequency to secure a wider range within which change in ACC liquid level height with respect to the SH difference is detected.

Thus, in air-conditioner 1, control device 100 controls refrigerant circuit 200 in the second operation mode to produce the SH difference, and can then detect the ACC liquid level height from the SH difference by referring to data on change in ACC liquid level height with respect to the SH difference as shown in FIG. 5. Control device 100 can calculate the amount of liquid refrigerant stored in container 71 of accumulator 70 based on the detected ACC liquid level height and a shape, a volume, or the like of container 71 stored in advance in storage 102.

When the condenser outlet SC is larger than 0, liquid refrigerant remains also in the condenser. Control device 100 is then configured to calculate an amount of liquid refrigerant that remains in the condenser other than liquid refrigerant stored in accumulator 70, based on a liquid phase area ratio A_{L} %.

Liquid phase area ratio A_{L} % represents a volume ratio of a liquid phase to a total volume of the condenser, and it is an indicator obtained by correcting the condenser outlet SC with an outside air temperature, discharge enthalpy of compressor 30, and a constant-pressure liquid specific heat of refrigerant. Specifically, control device 100 calculates liquid phase area ratio A_{L} % in accordance with an expression (1) below.

A_{L}%=−Ln(1−SC/dT_{c})*dT_{c}*C_{Pr}/Δh_{con} (1)

In the expression (1), SC represents the condenser outlet SC. dT_{c} represents a difference between an outside air temperature T5 measured by temperature sensor 95 and the condensation temperature. C_{Pr} represents constant-pressure liquid specific heat of refrigerant. Δh_{con} represents a difference between enthalpy in refrigerant at the condenser inlet and enthalpy in refrigerant at the condenser outlet.

Control device 100 can calculate an amount of liquid refrigerant stored in the condenser based on liquid phase area ratio A_{L} % calculated in accordance with the expression (1) and the shape, the volume, or the like of the condenser stored in advance in storage 102. For details of liquid phase area ratio A_{L} %, reference to Japanese U.S. Pat. No. 5,063,346 is to be made.

Control device 100 can thus calculate a total amount of liquid refrigerant that remains in refrigerant circuit 200 by calculating the amount of liquid refrigerant stored in accumulator 70, calculating the amount of liquid refrigerant stored in the condenser, and adding the amount of liquid refrigerant stored in accumulator 70 and the amount of liquid refrigerant stored in the condenser. In the evaporator, refrigerant is gasified and gasified refrigerant flows into accumulator 70, and hence no liquid refrigerant remains.

Control device 100 transmits to user device 500, liquid refrigerant amount data indicating the amount of liquid refrigerant stored in accumulator 70, the amount of liquid refrigerant stored in the condenser, or the total amount of liquid refrigerant that remains in refrigerant circuit 200 that is calculated. User device 500 notifies a user such as an operator on a display or the like, of the amount of liquid refrigerant stored in accumulator 70, the amount of liquid refrigerant stored in the condenser, and the total amount of liquid refrigerant that remains in refrigerant circuit 200 that is calculated, based on the liquid refrigerant amount data obtained from control device 100.

Air-conditioner 1 can thus calculate the amount of liquid refrigerant stored in accumulator 70 based on the SH difference between the ACC inlet SH and the ACC outlet SH and notify the operator of the calculated amount of liquid refrigerant, and hence the operator can more inexpensively check the amount of liquid refrigerant stored in accumulator 70.

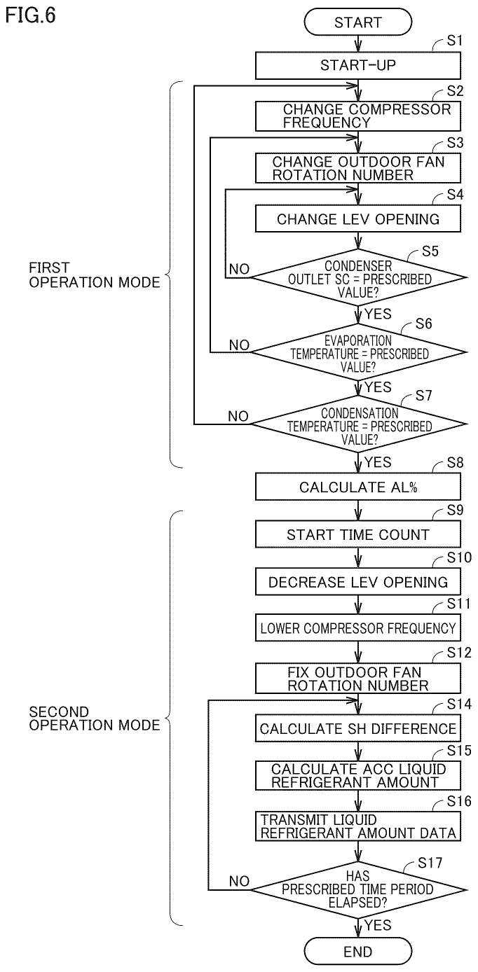

A specific flow of the refrigerant amount detection process performed by air-conditioner 1 will be described with reference to frig. 6. FIG. 6 is a flowchart for illustrating the refrigerant amount detection process performed by air-conditioner 1 according to the first embodiment. Control device 100 performs the refrigerant amount detection process in the flowchart shown in FIG. 6, for example, by executing a program stored in storage 102. “S” in the figure is used as an abbreviation of “STEP”.

As shown in FIG. 6, control device 100 starts up various components included in refrigerant circuit 200 of air-conditioner 1 (S1) and performs processing relating to the first operation mode. Specifically, control device 100 controls compressor 30 to change the compressor frequency (S2). Control device 100 controls outdoor fan 51 to change the outdoor fan rotation number (S3). Control device 100 controls indoor expansion valve 65 to change the LEV opening (S4).

Control device 100 determines whether or not the condenser outlet SC has attained to a prescribed value (S5). When the condenser outlet SC has not attained to the prescribed value (NO in S5), control device 100 again controls indoor expansion valve 65 to change the LEV opening (S4).

When condenser outlet SC has attained to the prescribed value (YES in S5), on the other hand, control device 100 determines whether or not the evaporation temperature has attained to a prescribed value (S6). When the evaporation temperature has not attained to the prescribed value (NO in S6), control device 100 again controls outdoor fan 51 to change the outdoor fan rotation number (S3).

When the evaporation temperature has attained to the prescribed value (YES in S6), on the other hand, control device 100 determines whether or not the condensation temperature has attained to a prescribed value (S7). When the condensation temperature has not attained to the prescribed value (NO in S7), control device 100 again controls compressor 30 to change the compressor frequency (S2).

Control device 100 can set the refrigeration cycle to the steady state as shown in FIG. 4, through processing relating to the first operation mode in S2 to S7 described above.

When the condensation temperature has attained to the prescribed value (YES in S7), control device 100 calculates liquid phase area ratio A_{L} % (S8). Control device 100 can thus calculate the amount of liquid refrigerant stored in the condenser.

Control device 100 then performs processing relating to the second operation mode. Specifically, control device 100 starts counting a prescribed time period for performing the processing relating to the second operation mode (S9).

Control device 100 controls indoor expansion valve 65 to change the LEV opening to set the LEV opening in the second operation mode to be smaller than the LEV opening in the first operation mode (S10).

Control device 100 controls compressor 30 to change the compressor frequency to set the compressor frequency in the second operation mode to be lower than the compressor frequency in the first operation mode (S11). For example, control device 100 controls compressor 30 to minimize the compressor frequency.

Control device 100 fixes the outdoor fan rotation number to a prescribed value to set the volume of air flow by outdoor fan 51 in the second operation mode to be equal to the volume of air flow by outdoor fan 51 in the first operation mode (S12).

Control device 100 calculates the SH difference while the SH difference is produced as shown in FIG. 4, through processing relating to the second operation mode in S10 to S12 described above (S14). Control device 100 calculates the amount of liquid refrigerant stored in accumulator 70 based on the calculated SH difference (S15). Specifically, control device 100 has data on change in ACC liquid level height with respect to the SH difference as shown in FIG. 5 stored in advance in storage 102, and calculates the ACC liquid level height based on the data and the calculated SH difference. Furthermore, control device 100 calculates the amount of liquid refrigerant stored in accumulator 70 based on the calculated ACC liquid level height and the shape, the volume, or the like of container 71 stored in advance in storage 102.

Control device 100 transmits to user device 500, the liquid refrigerant amount data indicating the amount of liquid refrigerant stored in accumulator 70, the amount of liquid refrigerant stored in the condenser, or the total amount of liquid refrigerant that remains in refrigerant circuit 200 that is calculated (S16). The operator can thus check the amount of liquid refrigerant stored in accumulator 70 with user device 500.

Control device 100 determines whether or not a prescribed time period has elapsed since start of counting in S9 (S17). When the prescribed time period has not elapsed since start of counting in S9 (NO in S17), the process returns to S14 and control device 100 again calculates the SH difference (S14). When the prescribed time period has elapsed since start of counting in S9 (YES in S17), on the other hand, control device 100 quits the present process. Control device 100 may calculate liquid phase area ratio A_{L} %, for example, before S14 or after S15, without being limited to calculation of liquid phase area ratio A_{L} % in S8.

As set forth above, since air-conditioner 1 according to the first embodiment can calculate the amount of liquid refrigerant stored in accumulator 70 based on the SH difference between the ACC inlet SH and the ACC outlet SH and notify the operator of the calculated amount of liquid refrigerant, the operator can more inexpensively check the amount of liquid refrigerant stored in accumulator 70.

### Second Embodiment

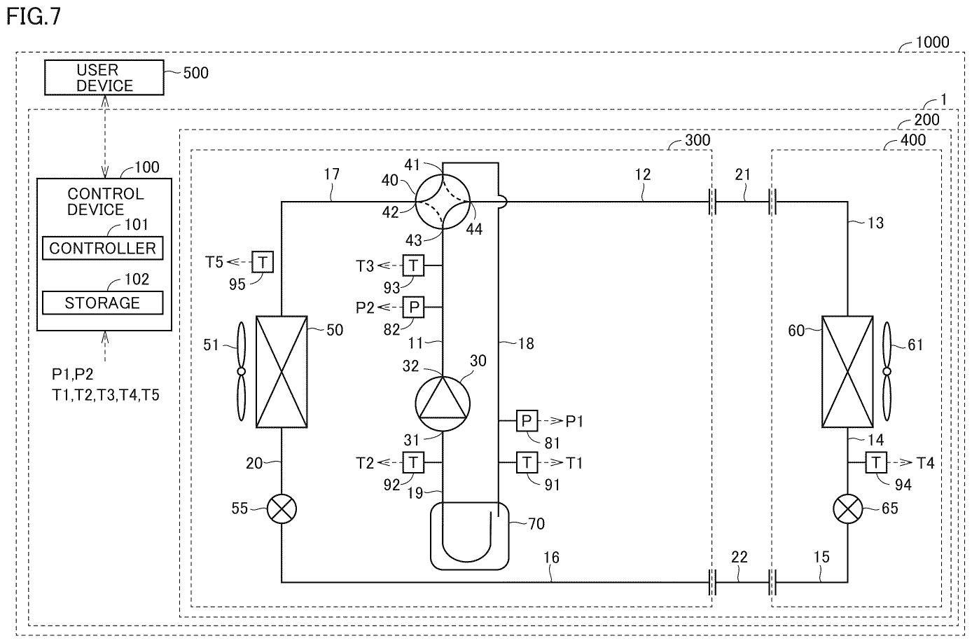

Air-conditioner 1 according to a second embodiment will be described with reference to FIG. 7. Features of air-conditioner 1 according to the second embodiment the same as those in air-conditioner 1 according to the first embodiment have the same reference numerals allotted. A feature different from air-conditioner 1 according to the first embodiment has a different reference numeral allotted and details thereof will be described below.

FIG. 7 is a diagram showing a configuration of air-conditioner 1 and air-conditioning system 1000 according to the second embodiment. As shown in FIG. 7, air-conditioner 1 according to the second embodiment further includes an outdoor expansion valve 55.

Outdoor expansion valve 55 is, for example, an electronic expansion valve an opening of which is adjusted under the control by control device 100. Outdoor expansion valve 55 lowers a pressure of refrigerant that flows in, and allows outflow of refrigerant obtained by pressure reduction. Control device 100 can adjust an amount of pressure reduction of refrigerant by adjusting the opening of outdoor expansion valve 55. One end side of outdoor expansion valve 55 is connected to indoor unit 400 through pipe 16 and extension pipe 22. The other end side of outdoor expansion valve 55 is connected to outdoor heat exchanger 50 through a pipe 20.

In air-conditioner 1 according to the second embodiment configured as described above, after the refrigeration cycle is set to the steady state in the first operation mode, control device 100 controls outdoor expansion valve 55 instead of indoor expansion valve 65 to set the opening of outdoor expansion valve 55 in the second operation mode to be smaller than the opening of outdoor expansion valve 55 in the first operation mode. Control device 100 can thus decrease the amount of refrigerant that flows to the evaporator also by decreasing the opening of outdoor expansion valve 55, and consequently it can set the ACC inlet SH to be higher than the ACC outlet SH and can produce the SH difference.

Control device 100 should only decrease the opening of at least one of indoor expansion valve 65 and outdoor expansion valve 55 in the second operation mode. In other words, in the second operation mode, control device 100 may decrease only the opening of indoor expansion valve 65, only the opening of outdoor expansion valve 55, or the opening of both of indoor expansion valve 65 and outdoor expansion valve 55.

### Third Embodiment

Air-conditioner 1 according to a third embodiment will be described. In air-conditioner 1 according to the first embodiment, in the second operation mode, control device 100 fixes the outdoor fan rotation number to the prescribed value to set the volume of air flow by outdoor fan 51 in the second operation mode to be equal to the volume of air flow by outdoor fan 51 in the first operation mode. In air-conditioner 1 according to the third embodiment, control device 100 may increase the outdoor fan rotation number in the second operation mode to set the volume of air flow by outdoor fan 51 in the second operation mode to be larger than the volume of air flow by outdoor fan 51 in the first operation mode.

When control device 100 thus sets the volume of air flow by outdoor fan 51 in the second operation mode to be larger than the volume of air flow by outdoor fan 51 in the first operation mode, it can further accelerate gasification of refrigerant that flows to the evaporator, and consequently it can set the ACC inlet SH to be higher than the ACC outlet SH and more readily produce the SH difference.

### Fourth Embodiment

Air-conditioner 1 according to a fourth embodiment will be described. In air-conditioner 1 according to the first embodiment, control device 100 is configured to detect the ACC liquid level height based on the SH difference produced in the second operation mode. The ACC inlet SH can be calculated by subtracting the evaporation temperature from the refrigerant temperature at the ACC inlet and the ACC outlet SH can be calculated by subtracting the evaporation temperature from the refrigerant temperature at the ACC outlet. In view of the fact that the same evaporation temperature is used for calculation of the ACC inlet SH and the ACC outlet SH, the SH difference between the ACC inlet SH and the ACC outlet SH is in proportion to the difference between refrigerant temperature T1 at the ACC inlet and refrigerant temperature T2 at the ACC outlet.

Then, in air-conditioner 1 according to the fourth embodiment, control device 100 may detect the ACC liquid level height based on the difference between refrigerant temperature T1 at the ACC inlet and refrigerant temperature T2 at the ACC outlet. Specifically, in the data shown in FIG. 5, the SH difference represented on the abscissa is replaced with the difference between refrigerant temperature T1 at the ACC inlet and refrigerant temperature T2 at the ACC outlet, so that control device 100 can obtain data on change in ACC liquid level height with respect to the difference between refrigerant temperature T1 at the ACC inlet and refrigerant temperature T2 at the ACC outlet. Control device 100 may use such data to detect the ACC liquid level height based on the difference between refrigerant temperature T1 at the ACC inlet and refrigerant temperature T2 at the ACC outlet.

The refrigerant amount detection process performed by air-conditioner 1 according to each of the first to fourth embodiments described above can be performed also in the cooling operation mode without being limited to the heating operation mode. In air-conditioner 1 according to each of the first to fourth embodiments described above, temperature sensor 92 provided between the outlet side of accumulator 70 and inlet 31 of compressor 30 is illustrated as the “second temperature sensor” to measure the temperature of refrigerant that flows out of accumulator 70. A temperature sensor provided at another position, however, may be applied as the “second temperature sensor.” For example, refrigerant temperature T2 of refrigerant that flows out of accumulator 70 is uniquely in coordination with temperature T3 of refrigerant discharged from compressor 30. Therefore, temperature sensor 93 may be applied as the “second temperature sensor” and refrigerant temperature T3 may be applied as the “second measurement result.” In this case, temperature sensor 92 does not have to be provided. In an example where compressor 30 has such a structure that a compression mechanism is contained in an airtight container filled with suctioned refrigerant or discharged refrigerant, a not-shown temperature sensor to sense a surface temperature of the airtight container may be applied as the “second temperature sensor” and the surface temperature of the airtight container may be applied as the “second measurement result.” Since the airtight container of compressor 30 is filled with refrigerant that flows out of accumulator 70, the surface temperature of the airtight container of compressor 30 corresponds to the temperature of refrigerant that flows out of accumulator 70.

### SUMMARY

Air-conditioner 1 in the present disclosure includes refrigerant circuit 200 including compressor 30, the condenser (for example, indoor heat exchanger 60), at least one expansion valve (for example, indoor expansion valve 65, outdoor expansion valve 55), and the evaporator (for example, outdoor heat exchanger 50), refrigerant circuit 200 being configured to circulate refrigerant, control device 100 to control refrigerant circuit 200, accumulator 70 in which liquid refrigerant is stored, accumulator 70 being configured to separate refrigerant that flows through refrigerant circuit 200 into liquid refrigerant and gas refrigerant, temperature sensor 91 to measure temperature T1 of refrigerant that flows into accumulator 70, and temperature sensor 92 to measure temperature T2 of refrigerant that flows out of accumulator 70. Accumulator 70 is arranged between compressor 30 and the evaporator. Control device 100 calculates the amount of liquid refrigerant stored in accumulator 70 based on refrigerant temperature T1 which is a result of measurement by temperature sensor 91 and refrigerant temperature T2 which is a result of measurement by temperature sensor 92.

According to such a configuration, air-conditioner 1 can calculate the amount of liquid refrigerant stored in accumulator 70 based on temperature T1 of refrigerant that flows into accumulator 70 and temperature T2 of refrigerant that flows out of accumulator 70, and hence the operator can more inexpensively check the amount of liquid refrigerant stored in accumulator 70.

Control device 100 calculates the amount of liquid refrigerant stored in accumulator 70 based on the difference between temperature T1 of refrigerant that flows into accumulator 70 and temperature T2 of refrigerant that flows out of accumulator 70.

According to the configuration above, air-conditioner 1 can calculate the amount of liquid refrigerant stored in accumulator 70 based on the difference between temperature T1 of refrigerant that flows into accumulator 70 and temperature T2 of refrigerant that flows out of accumulator 70, and hence the operator can more inexpensively check the amount of liquid refrigerant stored in accumulator 70.

Air-conditioner 1 further includes pressure sensor 81 to measure pressure P1 of refrigerant that flows into accumulator 70. Control device 100 calculates the degree of superheat (ACC inlet SH) of refrigerant that flows into accumulator 70 based on refrigerant pressure P1 which is a result of measurement by pressure sensor 81 and temperature T1 of refrigerant that flows into accumulator 70, calculates the degree of superheat (ACC outlet SH) of refrigerant that flows out of accumulator 70 based on refrigerant pressure P1 which is the result of measurement by pressure sensor 81 and temperature T2 of refrigerant that flows out of accumulator 70, and calculates the amount of liquid refrigerant stored in accumulator 70 based on the SH difference between the ACC inlet SH and the ACC outlet SH.

According to the configuration above, air-conditioner 1 can calculate the amount of liquid refrigerant stored in accumulator 70 based on the SH difference between the ACC inlet SH and the ACC outlet SH, and hence the operator can more inexpensively check the amount of liquid refrigerant stored in accumulator 70.

Control device 100 controls refrigerant circuit 200 in the first operation mode in which the SH difference between the ACC inlet SH and the ACC outlet SH is set to be smaller than a prescribed value, thereafter controls refrigerant circuit 200 in the second operation mode in which the SH difference between the ACC inlet SH and the ACC outlet SH is set to be equal to or larger than the prescribed value, and calculates the amount of liquid refrigerant stored in accumulator 70 in the second operation mode.

According to the configuration above, air-conditioner 1 controls refrigerant circuit 200 in the second operation mode to set the refrigeration cycle to the transient state to thereby produce the SH difference between the ACC inlet SH and the ACC outlet SH. Air-conditioner 1 can thus detect the amount of liquid refrigerant stored in accumulator 70 based on the SH difference produced in the second operation mode.

Control device 100 sets the opening of at least one expansion valve (for example, indoor expansion valve 65, outdoor expansion valve 55) in the second operation mode to be smaller than the opening of the at least one expansion valve (for example, indoor expansion valve 65, outdoor expansion valve 55) in the first operation mode.

According to the configuration above, air-conditioner 1 can decrease the amount of refrigerant that flows to the evaporator by decreasing the opening of at least one expansion valve (for example, indoor expansion valve 65, outdoor expansion valve 55), and consequently can set the ACC inlet SH to be higher than the ACC outlet SH and can produce the SH difference.

At least one expansion valve is indoor expansion valve 65 arranged in indoor unit 400 or outdoor expansion valve 55 arranged in outdoor unit 300.

According to the configuration above, air-conditioner 1 can decrease the amount of refrigerant that flows to the evaporator by decreasing the opening of at least one of indoor expansion valve 65 and outdoor expansion valve 55, and consequently can set the ACC inlet SH to be higher than the ACC outlet SH and can produce the SH difference.

Air-conditioner 1 further includes a fan (for example, outdoor fan 51) to send air to the evaporator. Control device 100 sets the volume of air flow by the fan in the second operation mode to be equal to the volume of air flow by the fan in the first operation mode.

According to the configuration above, air-conditioner 1 can decrease the amount of refrigerant that flows to the evaporator by decreasing the opening of at least one expansion valve (for example, indoor expansion valve 65, outdoor expansion valve 55) and maintaining the volume of air flow by the fan (for example, outdoor fan 51) to send air to the evaporator, and consequently can set the ACC inlet SH to be higher than the ACC outlet SH and can produce the SH difference.

Air-conditioner 1 further includes a fan (for example, outdoor fan 51) to send air to the evaporator. Control device 100 sets the volume of air flow by the fan in the second operation mode to be larger than the volume of air flow by the fan in the first operation mode.

According to the configuration above, air-conditioner 1 can decrease the amount of refrigerant that flows to the evaporator by decreasing the opening of at least one expansion valve (for example, indoor expansion valve 65, outdoor expansion valve 55) and increasing the volume of air flow by the fan (for example, outdoor fan 51) to send air to the evaporator, and consequently can set the ACC inlet SH to be higher than the ACC outlet SH and can produce the SH difference.

Control device 100 sets the frequency of compressor 30 in the second operation mode to be lower than the frequency of compressor 30 in the first operation mode.

According to the configuration above, air-conditioner 1 can accelerate gasification of refrigerant in the evaporator by setting the frequency of compressor 30 in the second operation mode to be lower than the frequency of compressor 30 in the first operation mode, and consequently can set the ACC inlet SH to be higher than the ACC outlet SH and can produce the SH difference. Furthermore, as shown in FIG. 5, air-conditioner 1 can secure a wider range within which change in ACC liquid level height with respect to the SH difference is detected as the frequency of compressor 30 in the second operation mode is lowered.

Air-conditioning system 1000 in the present disclosure includes air-conditioner 1 described above and user device 500 to give a notification of the amount of liquid refrigerant stored in accumulator 70, the amount being calculated by air-conditioner 1.

According to the configuration above, air-conditioning system 1000 can notify the operator of the amount of liquid refrigerant stored in accumulator 70, the amount being calculated by air-conditioner 1, with user device 500, and hence convenience of the operator is improved.

It should be understood that the embodiments disclosed herein are illustrative and non-restrictive in every respect. The scope of the present disclosure is defined by the terms of the claims rather than the description of the embodiments above and is intended to include any modifications within the scope and meaning equivalent to the terms of the claims.

### REFERENCE SIGNS LIST

1 air-conditioner; 11, 12, 13, 14, 15, 16, 17, 18, 19, 20 pipe; 21, 22 extension pipe; 30 compressor; 31 inlet; 32 outlet; 40 four-way valve; 41, 42, 43, 44 connection port; 50 outdoor heat exchanger; 51 outdoor fan; 55 outdoor expansion valve; 60 indoor heat exchanger; 61 indoor fan; 65 indoor expansion valve; 70 accumulator; 71 container; 72 inflow pipe; 73 outflow pipe; 73a gas inlet; 73b liquid inlet; 81, 82 pressure sensor; 91, 92, 93, 94, 95 temperature sensor; 100 control device; 101 controller; 102 storage; 200 refrigerant circuit; 300 outdoor unit; 400 indoor unit; 500 user device; 1000 air-conditioning system.

1. An air conditioner comprising:
a refrigerant circuit comprising a compressor, a condenser, at least one expansion valve, and an evaporator, the refrigerant circuit being configured to circulate refrigerant;
a control device configured to control the refrigerant circuit;
an accumulator where liquid refrigerant is stored, the accumulator being configured to separate refrigerant that flows through the refrigerant circuit into liquid refrigerant and gas refrigerant;
a first temperature sensor configured to measure a temperature of the refrigerant that flows into the accumulator; and
a second temperature sensor configured to measure a temperature of the refrigerant that flows out of the accumulator, wherein
the accumulator is arranged between the compressor and the evaporator, and
the control device calculates an amount of the liquid refrigerant stored in the accumulator, based on a first measurement result from the first temperature sensor and a second measurement result from the second temperature sensor.

2. The air-conditioner according to claim 1, wherein
the control device calculates the amount of the liquid refrigerant stored in the accumulator based on a difference between the first measurement result and the second measurement result.

3. The air-conditioner according to claim 2, further comprising a pressure sensor configured to measure a pressure of the refrigerant that flows into the accumulator, wherein
the control device
calculates a first degree of superheat of the refrigerant that flows into the accumulator based on a result of measurement by the pressure sensor and the first measurement result,
calculates a second degree of superheat of the refrigerant that flows out of the accumulator based on the result of measurement by the pressure sensor and the second measurement result, and
calculates the amount of the liquid refrigerant stored in the accumulator based on a difference between the first degree of superheat and the second degree of superheat.

4. The air-conditioner according to claim 3, wherein
the control device controls the refrigerant circuit in a first operation mode in which the difference between the first degree of superheat and the second degree of superheat is set to be smaller than a prescribed value, and thereafter the control device controls the refrigerant circuit in a second operation mode in which the difference between the first degree of superheat and the second degree of superheat is set to be equal to or larger than the prescribed value, and
the control device calculates the amount of the liquid refrigerant stored in the accumulator in the second operation mode.

5. The air-conditioner according to claim 4, wherein
the control device sets an opening of the at least one expansion valve in the second operation mode to be smaller than an opening of the at least one expansion valve in the first operation mode.

6. The air-conditioner according to claim 5, wherein
the at least one expansion valve is an indoor expansion valve arranged in an indoor unit or an outdoor expansion valve arranged in an outdoor unit.

7. The air-conditioner according to claim 5, further comprising a fan to send air to the evaporator, wherein
the control device sets a volume of air flow by the fan in the second operation mode to be equal to a volume of air flow by the fan in the first operation mode.

8. The air-conditioner according to claim 5, further comprising a fan to send air to the evaporator, wherein
the control device sets a volume of air flow by the fan in the second operation mode to be larger than a volume of air flow by the fan in the first operation mode.

9. The air-conditioner according to claim 5, wherein
the control device sets a frequency of the compressor in the second operation mode to be lower than a frequency of the compressor in the first operation mode.

10. An air-conditioning system comprising:
the air-conditioner according to claim 1; and
a user device to give a notification of the amount of the liquid refrigerant stored in the accumulator, the amount being calculated by the air-conditioner.
